(19) United States
(12) Patent Application Publication
(10) Pub. No.: US 2026/0292665 A1
(43) Pub. Date: Sep. 24, 2026

(54) NETWORK ENERGY SAVING WITH WAKE-UP SIGNAL TRANSMISSION RESTRICTIONS IN MOBILE COMMUNICATIONS

(71) Applicant: MediaTek Singapore Pte. Ltd., Singapore (SG)

(72) Inventors: Timothy James FROST, Oulu (FI); Wei-De WU, Hsinchu City (TW); Guillaume SEBIRE, Oulu (FI)

(73) Assignee: MediaTek Singapore Pte. Ltd., Singapore (SG)

(21) Appl. No.: 19/474,538

(22) PCT Filed: Oct. 17, 2024
(86) PCT No.: PCT/CN2024/125427

§ 371 Date: Oct. 10, 2025

Related U.S. Application Data
(60) Provisional application No. 63/590,788, filed on Oct. 17, 2023.

(51) Int. Cl. H04W 48/16; H04W 48/02; H04W 52/02; H04W 56/00; H04W 76/20

(52) U.S. Cl. CPC H04W 48/16; H04W 48/02; H04W 52/0235; H04W 56/0015; H04W 76/20

(57) ABSTRACT

Techniques pertaining to network energy saving with wake-up signal transmission restrictions in mobile communications are described. An apparatus (e.g., a user equipment (UE)) identifies a need to perform network discovery to identify a presence of a network or to identify an ability to obtain a service from the network. In response to the identifying, the apparatus performs an uplink (UL) transmission of a network wake-up signal with a restriction on the UL transmission.

### CROSS REFERENCE TO RELATED PATENT APPLICATION(S)

The present disclosure claims the priority benefit of U.S. Patent Application No. 63/590,788, filed 17 Oct. 2023, the content of which herein being incorporated by reference in its entirety.

### TECHNICAL FIELD

The present disclosure is generally related to mobile communications and, more particularly, to network energy saving with wake-up signal transmission restrictions in mobile communications.

### BACKGROUND

In wireless communications such as mobile communications under the current 3^{rd} Generation Partnership Project (3GPP) specification, a concept known as “on-demand SSB/SIB1” has been discussed with respect to network energy saving for New Radio (NR). Under this concept, a 5^{th} Generation (5G) NR cellular network would be allowed to completely stop all of its transmissions (including transmission of common channels and Synchronization Signal Block (SSB)) in order to minimize unnecessary network energy consumption. Moreover, due to the network not broadcasting any signal, in such a scenario, mobile devices performing cell search in idle mode would not be aware that there is a network available to potentially provide service. Therefore, if a user equipment (UE) in idle mode (as defined in 3GPP Technical Specification (TS) 38.304) finds itself outside of 5G NR coverage, it would be allowed to transmit a signal in the uplink (UL) direction to “discover” whether a 5G NR network is present and available. If a network receives such a signal, it would then activate transmission of downlink (DL) broadcast signals (including SSB and paging messages) on the cell corresponding to where the UL signal was received, and the UE would then be able to detect and select the cell for idle mode camping and paging reception. The aim of this concept is that the network is only required to transmit DL signals when there are mobile devices present that it needs to serve, even if only providing paging messages. Alternatively, a network targeting energy saving may only broadcast a minimal set of information, and this may not be enough information to allow the mobile device to identify whether it would be able to register on such a network. In this case, the mobile device needed to transmit a signal in the uplink direction to acquire further system information from the network to identify whether the network is accessible.

However, there remain challenges and potential improvements to the “on-demand SSB/system information” network energy saving concepts described above. For example, in many regulatory frameworks, it is not allowed for a mobile device to transmit on a frequency before it receives a signal from a network. This ensures that the mobile device will not cause uncontrolled interference to the spectrum. Allowing a mobile device to autonomously transmit signals in the UL direction without receiving any DL signal first may contravene such regulatory frameworks. One scenario of interest is where the mobile device leaves its home country of the subscriber and arrives in another “visited” country. In such a scenario, if the device does not find any coverage, it may assume it is still in its home country and start to transmit signals on the frequency band of the subscriber's home country. The problem with this is that in the “visited” country, the spectrum allocated for mobile usage may not be the same as in the subscriber's home country, and mobile device's transmissions may interference non-mobile services being used (whose operations may be affected by such mobile device transmissions). Another possibility is that the same device may support many mobile frequency bands and just start to send UL signals on all frequency bands that it supports, in case it believes it is not in its home country anymore. The problem caused by this may be the same as the above, but with other services likely to be affected by such transmissions. Another aspect is that if the device knows a network is available due to some minimal information being broadcast, then to acquire further information it would wake up the network and require it to consume more energy transmitting information to the mobile device without knowing if the mobile device has access to this network. Accordingly, it would be beneficial for the 3GPP standards to impose restrictions on the usage of such UL transmissions such that the interference impacts or increased energy consumption impacts (such as those described in above examples) may be prevented or otherwise minimized.

Therefore, there is a need for a solution of network energy saving with wake-up signal transmission restrictions in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to network energy saving with wake-up signal transmission restrictions in mobile communications. It is believed that implementations of one or more of the schemes proposed herein may address or otherwise alleviate the issues described above.

In one aspect, a method may involve a UE identifying a need to perform network discovery to identify a presence of a network or to identify an ability to obtain a service from the network. The method may also involve the UE performing, in response to the identifying, an uplink (UL) transmission of a network wake-up signal with a restriction on the UL transmission.

In another aspect, an apparatus may include a transceiver configured to communicate wirelessly and a processor coupled to the transceiver. The processor may identify a need to perform network discovery to identify a presence of a network or to identify an ability to obtain a service from the network. The processor may also perform, in response to the identifying, an UL transmission of a network wake-up signal with a restriction on the UL transmission.

It is noteworthy that, although the description provided herein may be in the context of certain radio access technologies, networks, and network topologies such as 5^{th} Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IOT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

Overview Implementations in accordance with the present disclosure relate to various techniques, methods, schemes and/or solutions pertaining to network energy saving with wake-up signal transmission restrictions in mobile communications. According to the present disclosure, a number of possible solutions may be implemented separately or jointly. That is, although these possible solutions may be described below separately, two or more of these possible solutions may be implemented in one combination or another.

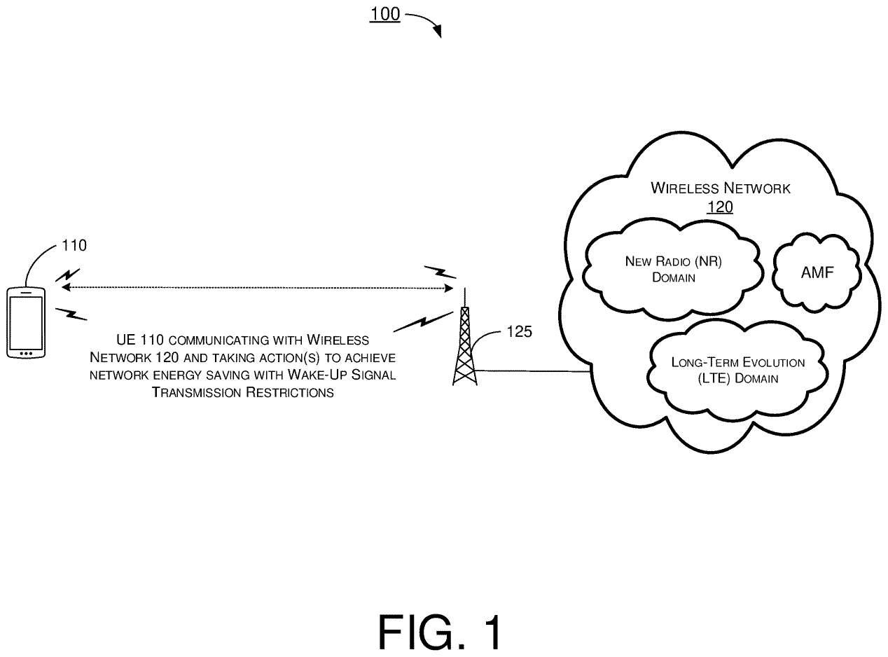

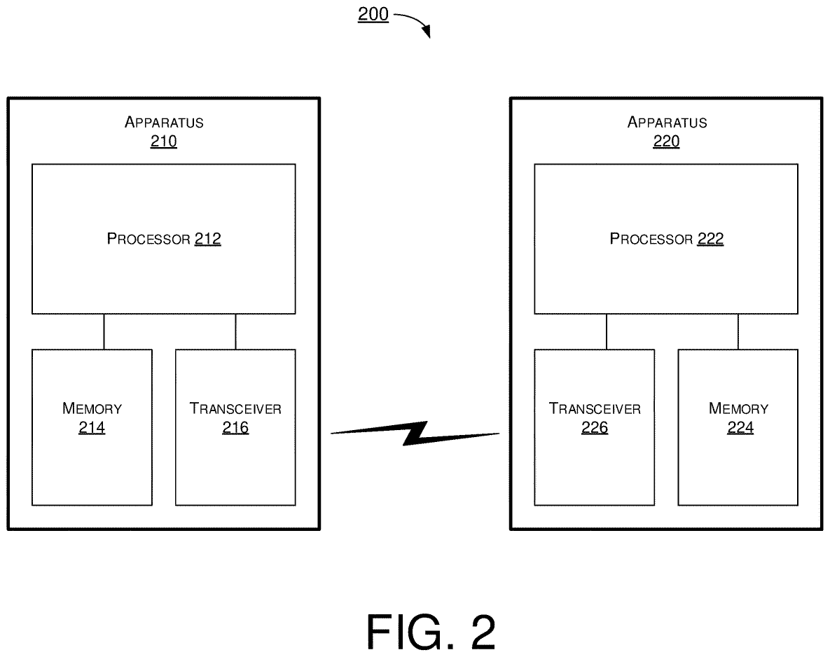

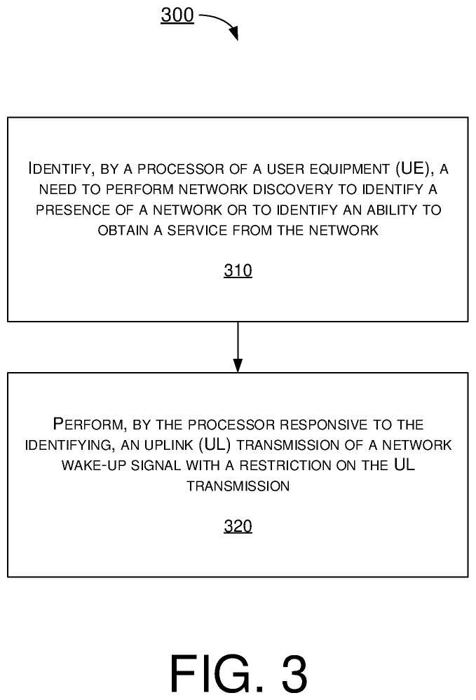

FIG. 1 illustrates an example network environment 100 in which various solutions and schemes in accordance with the present disclosure may be implemented. FIG. 2~FIG. 3 illustrate examples of implementation of various proposed schemes in network environment 100 in accordance with the present disclosure. The following description of various proposed schemes is provided with reference to FIG. 1~FIG. 3.

Referring to FIG. 1, network environment 100 may involve a UE 110, such as a mobile device or smartphone, in wireless communication with a wireless network 120 as part of a communication network. The wireless network 120 may be a PLMN including 5G/NR domain and 4G/LTE domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to network energy saving with wake-up signal transmission restrictions in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

In addition to the aforementioned challenges, one aspect is that, with respect to control via different radio access technologies (RATs) or different carrier frequencies, in case that a Base Station transmitter is completely switched off for 5G NR, it is likely that a legacy radio access technology is available to provide service in the same coverage area, but from a different Base Station. In such a scenario, if the mobile device is already camping on a cell of the legacy radio access technology or same carrier frequency, it would be possible for the Base Station providing that legacy technology cell to control whether and how the mobile device transmits UL transmissions to “discover” the availability of a 5G NR network.

Another aspect pertains to allowing only specific mobile devices to transmit network wake-up signals or allowing only transmission of network wake-up signals in certain scenarios. This relates to whether all mobile devices should be allowed to transmit network wake-up signals. It may be desirable only for devices requiring certain services to be allowed to transmit network wake-up signals (e.g., in the case of special users with a specific subscriber identity module (SIM) access class).

Under various proposed schemes in accordance with the present disclosure, UL transmission of “network wake-up” signals by a mobile device (e.g., UE 110) may be restricted via one or more of a number of mechanisms under the various proposed schemes described below.

Under a first proposed scheme in accordance with the present disclosure, certain means may be defined to control the behavior of UE 110 regarding UL transmission of network wake-up signals in case that UE 110 leaves mobile coverage and finds itself with no network availability due to no broadcast channels being transmitted by network 120 or in case that only the SSB is transmitted by network 120. Under the first proposed scheme, information to control UE 110 may include one or more of the following: (a) an indication of whether UE 110 is allowed to transmit network wake-up signals; (b) the frequencies on which UE 110 is allowed to transmit the network wake-up signal; (c) the allowed periodicity of UL transmission of the network wake-up signal; (d) the absolute time of day that UE 110 is allowed to transmit the network wake-up signal; (e) a timer with a specified or configured expiry time that is started when UE 110 identifies that there are no networks available (in the case of no broadcast channels transmitted by networks); after starting the timer and prior to expiry, UE 110 is allowed to transmit UL signals to discover the availability of a 5G network; and after the timer expires UE 110 is no longer allowed to transmit such signals; and (f) a restriction on the geographical location in which UE 110 is allowed to transmit the network wake-up signal (e.g., UE 110 may obtain its geographical location by means of a Global Navigation Satellite System (GNSS) such as Global Positioning System (GPS), or any other means).

Under a second proposed scheme in accordance with the present disclosure, certain means may be defined to control the behavior of UE 110 regarding UL transmission of network wake-up signals in case that UE 110 leaves mobile coverage and finds itself with no network availability due to no broadcast channels being transmitted by network 120 or if only the SSB is transmitted by network 120, such that UE 110 is only allowed to transmit UL network wake-up signals on certain frequencies. Under the second proposed scheme, such frequencies may be indicated as belonging to one of the following: (a) the same carrier frequency that was serving UE 110 prior to detection of no coverage; (b) the same frequency band that was serving UE 110 prior to detection of no coverage; (c) frequency bands of the same network (e.g., public land mobile network (PLMN)) that was serving UE 110 prior to detection of no coverage; (d) frequency bands of the same network (e.g., PLMN) or equivalent network (e.g. equivalent PLMN) of the network that was serving UE 110 prior to detection of no coverage; (e) frequency bands available for mobile usage in the same country of the network that was serving UE 110 prior to detection of no coverage (e.g., the country being identified by the Mobile Country Code (MCC) which is part of the PLMN identifier in mobile networks); and (f) known frequency band(s) available for mobile usage in the country of location of UE 110 and depending on the network (e.g. visited PLMN (VPLMN)) which UE 110 is allowed to attempt to access for normal service or emergency service (as configured on the Universal Integrated Circuit Card (UICC) of UE 110).

Under a third proposed scheme in accordance with the present disclosure, certain means may be defined to control the behavior of UE 110 regarding UL transmission of network wake-up signals to discover networks on other carrier frequencies in case that UE 110 is camped on a network in either connected mode or idle mode using an existing carrier frequency. Under the third proposed scheme, information to control UE 110 may include one or more of the following: (a) an indication of whether UE 110 is allowed to transmit network wake-up signals; (b) the frequencies on which UE 110 is allowed to transmit the network wake-up signal; (c) the allowed periodicity of UL transmission of the network wake-up signal; (d) the absolute time of day that UE 110 is allowed to transmit the network wake-up signal; (e) a timer with a specified or configured expiry time that is started when UE 110 receives the information from the network such that, after the timer expires, UE 110 is no longer allowed to transmit network wake-up signals; and (f) a restriction on the geographical location in which UE 110 is allowed to transmit the network wake-up signal (e.g., UE 110 may obtain its geographical location by means of a GNSS such as GPS or limited by Registration Area or RAN Notification/Registration Area, or by any other means).

Under a fourth proposed scheme in accordance with the present disclosure, certain means may be defined to control the behavior of UE 110 regarding UL transmission of network wake-up signals on other carrier frequencies in case that UE 110 is camped on a network either in connected mode or idle mode using an existing carrier frequency, such that UE 110 is only allowed to transmit network wake-up signals on certain frequencies. Under the fourth proposed schemes, such frequencies may be indicated as belonging to one of the following: (a) different frequency bands of the same network (e.g., PLMN) that is serving UE 110; (b) different frequency bands of the same network (e.g., PLMN) or equivalent network (e.g. equivalent PLMN) of the network that is serving UE 110; (c) frequency bands available for mobile usage in the same country of the network that that is serving UE 110 (e.g., with the country being identified by the MCC which is part of the PLMN identifier in mobile networks); and (d) known frequency band(s) available for mobile usage in the country of location of UE 110 and depending on the network (e.g., VPLMN) which UE 110 is allowed to attempt to access for normal service or emergency service (as configured on the UICC).

Under a fifth proposed scheme in accordance with the present disclosure, certain means may be defined to control the behavior of UE 110 regarding UL transmission of network wake-up signals in case that UE 110 leaves mobile coverage and finds itself with no network availability due to no broadcast channels being transmitted by network 120 or if only the SSB is transmitted by network 120. Under the fifth proposed scheme, UE 110 may be not allowed to transmit network wake-up signals for one radio access technology (e.g., 6^{th} Generation (6G)) in case that UE 110 is being served by another radio access technology (e.g. 5G NR). Alternatively, or additionally, UE 110 may be not allowed to transmit network wake-up signals for one radio access technology (e.g., 6G) on the same carrier frequency from which UE 110 is being served by another radio access technology (e.g., 5G NR).

Under a sixth proposed scheme in accordance with the present disclosure, the information in any or all of the above-described first, second, third, fourth and fifth proposed schemes may be limited for operation only to certain mobile devices (e.g., depending on the subscriber type or specific subscriber identity).

Under a seventh proposed scheme in accordance with the present disclosure, the information in any or all of the above-described first, second, third, fourth, fifth and sixth proposed schemes may be specified as mobile device standard behavior in relevant technology standards such as those defined in 3GPP. Alternatively, or additionally, the information in any or all of the above-described first, second, third, fourth, fifth and sixth proposed schemes may be configured to UE 110 via signaling from the mobile network of the same radio access technology for which UE 110 transmits network wake-up signals, or via a different radio access technology (e.g., an LTE network may configure UE 110 with information to control its behavior for 5G NR or 6G UL transmission of network wake-up signals). The signaling may be provided via the Core Network non-access stratum (NAS) or via the Radio Access Network (e.g., via radio resource control (RRC) signaling). Alternatively, or additionally, the information in any or all of the above-described first, second, third, fourth, fifth and sixth proposed schemes may be stored in the Subscriber Identity Module (SIM) of UE 110 and retrieved from the SIM by UE 110.

Under an eighth proposed scheme in accordance with the present disclosure, the information in any or all of the above-described first, second, third, fourth, fifth and sixth proposed schemes may be configured to a mobile device (e.g., UE 110) via signaling from a mobile network, then the information may optionally be ciphered by the network using a public or private key secure mechanism such that only the network and the receiving mobile device know the information.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to network energy saving with wake-up signal transmission restrictions in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G NR network, a 6G network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to network energy saving with wake-up signal transmission restrictions in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example process 300.

### Illustrative Processes

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to network energy saving with wake-up signal transmission restrictions in mobile communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210, as a UE, identifying a need to perform network discovery to identify a presence of a network (e.g., network 120) or to identify an ability of apparatus 210 to obtain a service from the network (e.g., via apparatus 220 as network node 125). Process 300 may proceed from 310 to 320.

At 320, process 300 may involve processor 212, in response to the identifying, performing, via transceiver 216, an UL transmission of a network wake-up signal with a restriction on the UL transmission.

In some implementations, the restriction may include a restriction on at least one of a frequency, a time, a periodicity, a geographical location or a RAT of the UL transmission.

In some implementations, the restriction may include a restriction on the UE in performing the UL transmission to discover one or more networks on one or more other carrier frequencies responsive to the UE being camped on a network either in a connected mode or an idle mode using an existing carrier frequency.

In some implementations, in response to the UE leaving a mobile coverage and being with no network availability, the restriction may include either or both of the following: (i) the UE being not allowed to transmit network wake-up signals using a first RAT in an event that the UE is being served by a second RAT; and (ii) the UE being not allowed to transmit the network wake-up signals using the first RAT on a same carrier frequency from which the UE is being served by the second RAT. In some implementations, the first RAT may include 6G, and the second RAT may include 5G NR.

In some implementations, the restriction may include a restriction depending on a subscriber type or a specific subscriber identity associated with the UE.

In some implementations, in identifying the need, process 300 may involve processor 212 identifying the need based on: (i) the UE leaving a mobile coverage and being with no network availability due to no broadcast channels being transmitted by a network; or (ii) only a SSB being transmitted by the network.

In some implementations, in performing the UL transmission, process 300 may involve processor 212 performing the UL transmission on one or more frequencies belonging to one or more of the following: (a) a same carrier frequency that was serving the UE prior to a detection of no coverage; (b) a same frequency band that was serving the UE prior to the detection of no coverage; (c) one or more frequency bands of a same network that was serving the UE prior to the detection of no coverage; (d) one or more frequency bands of the same network or an equivalent network that was serving the UE prior to the detection of no coverage; (e) one or more frequency bands available for mobile usage in a same country of a network that was serving the UE prior to the detection of no coverage; and (f) one or more known frequency bands available for mobile usage in a country where the UE is located from which the UE is allowed to attempt to access for a normal service or emergency service.

In some implementations, in response to the UE being camped on a network either in a connected mode or an idle mode using an existing carrier frequency, in performing the UL transmission, process 300 may involve processor 212 performing the UL transmission on one or more frequencies belonging to one or more of the following: (a) one or more different frequency bands of the network that is serving the UE; (b) one or more different frequency bands of an equivalent network that is serving the UE; (c) one or more frequency bands available for mobile usage in a same country of the network that that is serving the UE; and (d) one or more known frequency bands available for mobile usage in a country where the UE is located from which the UE is allowed to attempt to access for a normal service or emergency service.

In some implementations, prior to the performing of the UL transmission, process 300 may further involve processor 212 obtaining information related to the restriction. The information may include one or more of the following: (a) an indication of whether the UE is allowed to transmit the network wake-up signal; (b) one or more frequencies on which the UE is allowed to transmit the network wake-up signal; (c) a allowed periodicity of the UL transmission of the network wake-up signal; (d) an absolute time of day that the UE is allowed to transmit the network wake-up signal; (e) a timer with a specified or configured expiry time that is started when the UE determines that there are no networks available such that, after starting the timer and prior to expiry of the timer, the UE is allowed to transmit the network wake-up signal to discover an availability of a 5G network and that, after the expiry of the timer, the UE is not allowed to transmit network wake-up signals; and (f) a geographical location in which the UE is allowed to transmit the network wake-up signal.

In some implementations, in obtaining the information related to the restriction, process 300 may involve processor 212 receiving a signaling from a network of a same RAT with which the UE transmits the network wake-up signal or via a different RAT. In some implementations, the information may be specified as a mobile device standard behavior in one or more technology standards (e.g., 3GPP). In some implementations, the signaling may include a Core Network NAS signaling. In some implementations, in receiving the signaling, process 300 may involve processor 212 receiving a RRC signaling. In some implementations, the information may be ciphered by the network using a public or private key secure mechanism. Alternatively, or additionally, in obtaining the information related to the restriction, process 300 may involve processor 212 retrieving the information from a SIM of the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
identifying, by a processor of a user equipment (UE), a need to perform network discovery to identify a presence of a network or to identify an ability to obtain a service from the network; and
performing, by the processor responsive to the identifying, an uplink (UL) transmission of a network wake-up signal with a restriction on the UL transmission.

2. The method of claim 1, wherein the restriction comprises a restriction on at least one of a frequency, a time, a periodicity, a geographical location or a radio access technology (RAT) of the UL transmission.

3. The method of claim 1, wherein the restriction comprises a restriction on the UE in performing the UL transmission to discover one or more networks on one or more other carrier frequencies responsive to the UE being camped on a network either in a connected mode or an idle mode using an existing carrier frequency.

4. The method of claim 1, wherein, responsive to the UE leaving a mobile coverage and being with no network availability, the restriction comprises either or both of:
the UE being not allowed to transmit network wake-up signals using a first radio access technology (RAT) in an event that the UE is being served by a second RAT; and
the UE being not allowed to transmit the network wake-up signals using the first RAT on a same carrier frequency from which the UE is being served by the second RAT.

5. The method of claim 4, wherein the first RAT comprises 6^{th} Generation (6G), and wherein the second RAT comprises 5^{th} Generation (5G) New Radio (NR).

6. The method of claim 1, wherein the restriction comprises a restriction depending on a subscriber type or a specific subscriber identity associated with the UE.

7. The method of claim 1, wherein the identifying the need comprises identifying the need based on:
the UE leaving a mobile coverage and being with no network availability due to no broadcast channels being transmitted by a network; or only a synchronization signal block (SSB) being transmitted by the network.

8. The method of claim 1, wherein the performing of the UL transmission comprises performing the UL transmission on one or more frequencies belonging to one or more of:
a same carrier frequency that was serving the UE prior to a detection of no coverage;
a same frequency band that was serving the UE prior to the detection of no coverage;
one or more frequency bands of a same network that was serving the UE prior to the detection of no coverage;
one or more frequency bands of the same network or an equivalent network that was serving the UE prior to the detection of no coverage;
one or more frequency bands available for mobile usage in a same country of a network that was serving the UE prior to the detection of no coverage; and
one or more known frequency bands available for mobile usage in a country where the UE is located from which the UE is allowed to attempt to access for a normal service or emergency service.

9. The method of claim 1, wherein, responsive to the UE being camped on a network either in a connected mode or an idle mode using an existing carrier frequency, the performing of the UL transmission comprises performing the UL transmission on one or more frequencies belonging to one or more of:
one or more different frequency bands of the network that is serving the UE;
one or more different frequency bands of an equivalent network that is serving the UE;
one or more frequency bands available for mobile usage in a same country of the network that that is serving the UE; and
one or more known frequency bands available for mobile usage in a country where the UE is located from which the UE is allowed to attempt to access for a normal service or emergency service.

10. The method of claim 1, further comprising, prior to the performing of the UL transmission:
obtaining, by the processor, information related to the restriction, the information comprising one or more of:
an indication of whether the UE is allowed to transmit the network wake-up signal;
one or more frequencies on which the UE is allowed to transmit the network wake-up signal;
an allowed periodicity of the UL transmission of the network wake-up signal;
an absolute time of day that the UE is allowed to transmit the network wake-up signal;
a timer with a specified or configured expiry time that is started when the UE determines that there are no networks available such that, after starting the timer and prior to expiry of the timer, the UE is allowed to transmit the network wake-up signal to discover an availability of a 5^{th} Generation (5G) network and that, after the expiry of the timer, the UE is not allowed to transmit network wake-up signals; and
a geographical location in which the UE is allowed to transmit the network wake-up signal.

11. The method of claim 10, wherein the obtaining of the information related to the restriction comprises receiving a signaling from a network of a same radio access technology (RAT) with which the UE transmits the network wake-up signal or via a different RAT.

12. The method of claim 11, wherein the receiving of the signaling comprises receiving a radio resource control (RRC) signaling, or wherein the receiving of the signaling comprises a core network non-access stratum (NAS) signaling.

13. The method of claim 11, wherein the information is ciphered by the network using a public or private key secure mechanism.

14. The method of claim 10, wherein the obtaining of the information related to the restriction is specified as a mobile device standard behavior in one or more technology standards.

15. The method of claim 10, wherein the obtaining of the information related to the restriction comprises retrieving the information from a subscriber identity module (SIM) of the UE.

16. An apparatus implementable in a user equipment (UE), comprising:
a transceiver configured to communicate wirelessly; and
a processor coupled to the transceiver and configured to perform operations comprising:
identifying a need to perform network discovery to identify a presence of a network or to identify an ability to obtain a service from the network; and
performing, via the transceiver and responsive to the identifying, an uplink (UL) transmission of a network wake-up signal with a restriction on the UL transmission.

17. The apparatus of claim 16, wherein the restriction comprises one of:
a restriction on at least one of a frequency, a time, a periodicity, a geographical location or a radio access technology (RAT) of the UL transmission;
a restriction on the UE in performing the UL transmission to discover one or more networks on one or more other carrier frequencies responsive to the UE being camped on a network either in a connected mode or an idle mode using an existing carrier frequency; or
a restriction depending on a subscriber type or a specific subscriber identity associated with the UE.

18. The apparatus of claim 16, wherein, responsive to the UE leaving a mobile coverage and being with no network availability, the restriction comprises either or both of:
the UE being not allowed to transmit network wake-up signals using a first radio access technology (RAT) in an event that the UE is being served by a second RAT; and
the UE being not allowed to transmit the network wake-up signals using the first RAT on a same carrier frequency from which the UE is being served by the second RAT,
wherein the first RAT comprises 6^{th} Generation (6G), and wherein the second RAT comprises 5^{th} Generation (5G) New Radio (NR).
